(19) United States
(12) Patent Application Publication
(10) Pub. No.: US 2024/0027672 A1
(43) Pub. Date: Jan. 25, 2024

(54) BACKLIGHT MODULE AND DISPLAY DEVICE

(71) Applicant: WUHAN CHINA STAR OPTOELECTRONICS TECHNOLOGY CO., LTD., Wuhan, Hubei (CN)

(72) Inventors: Lei Zhu, Wuhan, Hubei (CN); Jie Zhang, Wuhan, Hubei (CN)

(73) Assignee: WUHAN CHINA STAR OPTOELECTRONICS TECHNOLOGY CO., LTD., Wuhan, Hubei (CN)

(21) Appl. No.: 17/614,322

(22) PCT Filed: Sep. 29, 2021
(86) PCT No.: PCT/CN2021/121753

§ 371 Date: Nov. 24, 2021

(30) Foreign Application Priority Data
Sep. 23, 2021 (CN) 202111110616.0

(51) Int. Cl. F21V 8/00; G02F 1/1335

(52) U.S. Cl. CPC G02B 6/0021; G02B 6/0068; G02F 1/133607; G02B 6/0031

(57) ABSTRACT

The present disclosure provides a backlight module and a display device; the backlight module includes a light guide plate, a first light emitting module and a second light emitting module; a plurality of protrusion portions and a plurality of groove portions are defined on at least one side edge of the light guide plate; the first light emitting module includes a plurality of first light emitting elements disposed corresponding to the groove portions and light emitting surfaces of the first light emitting elements face corresponding first light incident surfaces; the second light emitting module includes a plurality of second light emitting elements disposed corresponding to the protruding portions, and light emitting surfaces of the second light emitting elements face corresponding second light incident surfaces.

The present disclosure claims priority to a Chinese patent application, which is filed with the Chinese Patent Office on Sep. 23, 2021, having application No. 202111110616.0, and invention titled “Backlight Module and Display Device”, the entire content of which is incorporated into the present disclosure by reference.

### TECHNICAL FIELD

The present disclosure relates to a field of display technology, and more particularly to a backlight module and a display device.

### BACKGROUND

When a mobile phone is used in different scenarios, display brightness as required is different. When in a dark environment, a mobile phone screen can be seen clearly at a lower display brightness; when in an outdoor environment with strong light, the mobile phone screen can be seen clearly at a higher display brightness to normally use the mobile phone. Currently, the mobile phone usually changes display brightness levels by adjusting current levels, a specific method is to control brightness of backlight LEDs (light emitting diodes) as a whole by adjusting the current levels. When a low brightness display is required, the backlight LEDs are enabled to emit a lower brightness light through a small current. When a high brightness display is required, the backlight LEDs are enabled to emit a higher brightness light through a larger current. However, when working with a large current (more than approximately 23 mA), a service life of LEDs is greatly reduced, thereby affecting a service life of the mobile phone.

### SUMMARY

At present, when a mobile phone is displayed with high brightness, there is a technical problem that a service life of backlight LEDs is low.

The present disclosure provides a backlight module and a display device, which are used to alleviate at least one technical problem that a service life of backlight LEDs is low when a display device is displayed with a high brightness.

The present disclosure provides a backlight module, including:
A light guide plate, wherein a plurality of protrusion portions and a plurality of groove portions are defined on at least one side edge of the light guide plate, and the plurality of groove portions include a plurality of first light incident surfaces, and the plurality of protrusion portions include a plurality of second light incident surfaces.
A first light emitting module, wherein the first light emitting module includes a plurality of first light emitting elements, the first light emitting elements are disposed corresponding to the groove portions, and light emitting surfaces of the first light emitting elements face corresponding first light incident surfaces.
A second light emitting module, wherein the second light emitting module includes a plurality of second light emitting elements, the second light emitting elements are disposed corresponding to the protruding portions, and light emitting surfaces of the second light emitting elements face corresponding second light incident surfaces.

In the backlight module of the present disclosure, the first light emitting module is driven to emit light by a first driving circuit, and the second light emitting module is driven to emit light by a second driving circuit.

The first driving circuit and the second driving circuit are independent of each other.

In the backlight module of the present disclosure, the backlight module includes a first light emitting mode and a second light emitting mode.

In the first light emitting mode, the first light emitting module emits light, and the second light emitting module does not emit light.

In the second light emitting mode, both the first light emitting module and the second light emitting module emit light.

In the backlight module of the present disclosure, the first light emitting module emits a first light, and the second light emitting module emits a second light, and the first light and the second light are different from each other.

A brightness of the first light is different from a brightness of the second light.

In the backlight module of the present disclosure, reflective layers are disposed on side walls of each of the protruding portions close to adjacent groove portions.

In the backlight module of the present disclosure, the reflective layers cover partial edge areas of the first light incident surfaces.

In the backlight module of the present disclosure, the reflective layers cover partial edge areas of the second light incident surfaces.

In the backlight module of the present disclosure, the backlight module includes a light emitting region, and a distance from the first light emitting module to the light emitting region is less than a distance from the second light emitting module to the light emitting region.

In the backlight module of the present disclosure, the plurality of protruding portions and the plurality of groove portions are defined spaced apart from each other.

In the backlight module of the present disclosure, one or more groove portions are defined between two adjacent protruding portions.

In the backlight module of the present disclosure, the first light emitting module includes a first series group and a second series group, the first series group includes a first number of the first light emitting elements connected in series, the second series group includes a second number of the first light emitting elements connected in series, and the first series group and the second series group are connected in parallel.

In the backlight module of the present disclosure, all the first light emitting elements in the first light emitting module are connected in series in the first driving circuit.

In the backlight module of the present disclosure, the second light emitting module includes a third series group and a fourth series group, the third series group includes a third number of the second light emitting elements connected in series, the fourth series group includes a fourth number of the second light emitting elements connected in series, and the third series group and the fourth series group are connected in parallel.

In the backlight module of the present disclosure, all the second light emitting elements in the second light emitting module are connected in series in the second driving circuit.

In the backlight module of the present disclosure, the backlight module further includes a frame body and a light reflecting plate, the light reflecting plate and the light guide plate are both disposed in the frame body, and the light guide plate is disposed on the light reflecting plate.

In the backlight module of the present disclosure, the backlight module further includes an optical film group disposed on the light guide plate, and the optical film group includes a diffusion plate, a prism sheet, and a brightness enhancement plate.

In the backlight module of the present disclosure, light scattering dots are disposed at an interface between the light reflecting plate and the light guide plate, and the light scattering dots are configured to scatter light irradiated to surfaces thereof.

The present disclosure further provides a display device, including: the backlight module as described above, and a display panel disposed on a light emitting surface of the backlight module.

The present disclosure further provides a display device, including: a backlight module, and a display panel disposed on a light emitting surface of the backlight module, wherein the backlight module includes:
A light guide plate, wherein a plurality of protrusion portions and a plurality of groove portions are defined on at least one side edge of the light guide plate, and the plurality of groove portions include a plurality of first light incident surfaces, and the plurality of protrusion portions include a plurality of second light incident surfaces, and reflective layers are disposed on side walls of each of the protruding portions close to the adjacent groove portions.
A first light emitting module, wherein the first light emitting module includes a plurality of first light emitting elements, the first light emitting elements are disposed corresponding to the groove portions, and light emitting surfaces of the first light emitting elements face corresponding first light incident surfaces.
A second light emitting module, wherein the second light emitting module includes a plurality of second light emitting elements, the second light emitting elements are disposed corresponding to the protruding portions, and light emitting surfaces of the second light emitting elements face corresponding second light incident surfaces.

The first light emitting module and the second light emitting module emit light independently of each other.

The present disclosure provides the backlight module and the display device, the backlight module includes the light guide plate, the first light emitting module, and the second light emitting module, the plurality of protrusion portions and the plurality of groove portions are defined on at least one side edge of the light guide plate, the first light emitting module includes the plurality of first light emitting elements, the light emitting surfaces of the first light emitting elements face the first light incident surfaces, and the second light emitting module includes the plurality of second light emitting elements, the light emitting surfaces of the second light emitting elements face the second light incident surfaces. The present disclosure provides two groups of light emitting modules, and the two groups of light emitting modules are respectively disposed corresponding to the groove portions and the protrusion portions of the light guide plate, which is beneficial by setting a greater number of light emitting elements on one side edge of the light guide plate, thereby maximum light emitting brightness of the backlight module is improved, and a current demand of a single light emitting element can also be reduced at a specific light emitting brightness, which is beneficial to improve a service life of light emitting elements.

### DESCRIPTION OF DRAWINGS

In order to more clearly explain the technical solutions in the embodiments of the present disclosure, the following briefly introduces the drawings used in descriptions of the embodiments. Obviously, the drawings in the following description are only some embodiments of the present disclosure. For those skilled in the art, other drawings may be obtained based on these drawings without creative work.

FIG. 1 is a schematic structural diagram of a first film layer of a backlight module provided by an embodiment of the present disclosure.

FIG. 2 is a schematic diagram of a planar structure of a backlight module provided by an embodiment of the present disclosure.

FIG. 3 is a schematic diagram of a planar structure of a light guide plate provided by an embodiment of the present disclosure.

FIG. 4 is a circuit driving schematic diagram of a first light emitting module provided by an embodiment of the present disclosure.

FIG. 5 is a circuit driving schematic diagram of a second light emitting module provided by an embodiment of the present disclosure.

FIG. 6 is a schematic structural diagram of a second film layer of a backlight module provided by an embodiment of the present disclosure.

FIG. 7 is a schematic structural diagram of a display device provided by an embodiment of the present disclosure.

### DETAILED DESCRIPTION OF PREFERRED EMBODIMENTS

The following description of embodiments is provided with reference to accompanying drawings, which are used to exemplify specific embodiments that can be implemented by the present disclosure. Directional terms mentioned in the present disclosure, such as “upper”, “lower”, “front”, “back”, “left”, “right”, “inner”, “outer”, “side”, etc., are merely directions with reference to the accompanying drawings. Therefore, the used directional terms are used to describe and understand the present disclosure, and are not intended to limit the present disclosure. In the drawings, units with similar structures are denoted by same reference numerals.

The present disclosure provides a backlight module and a display device, the backlight module includes at minimum a light guide plate, a first light emitting module, and a second light emitting module, a plurality of protrusion portions and a plurality of groove portions are defined on at least one side edge of the light guide plate, the plurality of groove portions include a plurality of first light incident surfaces, the plurality of protrusion portions include a plurality of second light incident surfaces, the first light emitting module includes a plurality of first light emitting elements, the first light emitting elements are disposed corresponding to the groove portions, and light emitting surfaces of the first light emitting elements face corresponding first light incident surfaces, the second light emitting module includes a plurality of second light emitting elements, the second light emitting elements are disposed corresponding to the protruding portions, and light emitting surfaces of the second light emitting elements face corresponding second light incident surfaces.

The backlight module provided by the embodiment of the present disclosure includes the first light emitting module and the second light emitting module, and the first light emitting module is disposed in the groove portions of the light guide plate, and the second light emitting module is disposed on the protrusion portions of the light guide plate, so that the backlight module has an ability to emit light of at least two kinds of brightness, during high brightness display, the first light emitting module and the second light emitting module emit light at a same time, so that brightness is improved without increasing a current level, which is beneficial to improving a service life of the backlight module; and a concave-convex structure on at least one edge of the light guide plate facilitates a uniform fusion of light emitted by the second light emitting module and light emitted by the first light emitting module, thereby improving a quality of light emitted by the backlight module.

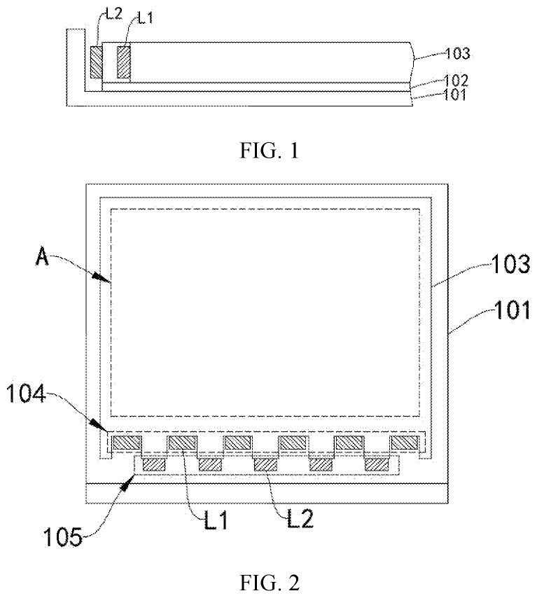

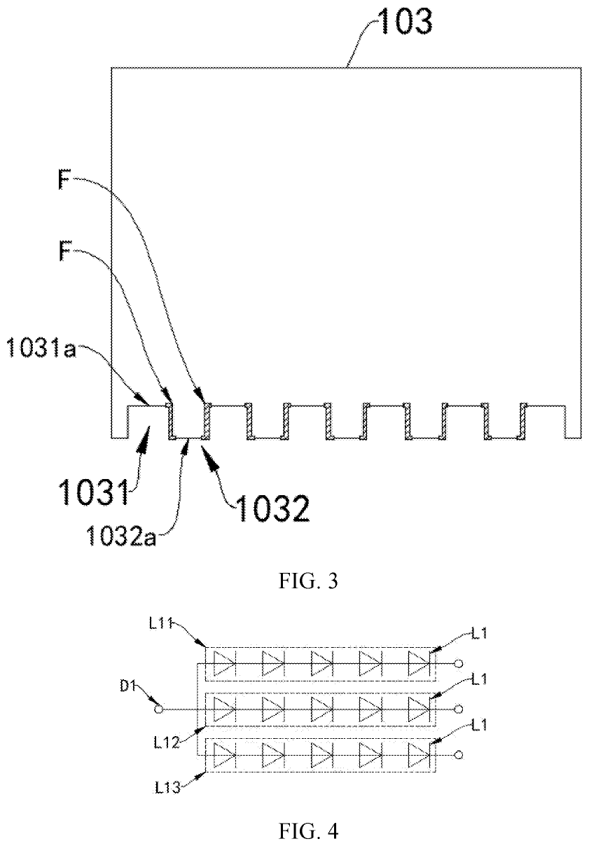

Please refer to FIG. 1 to FIG. 3, FIG. 1 is a schematic structural diagram of a first film layer of a backlight module provided by an embodiment of the present disclosure, FIG. 2 is a schematic diagram of a planar structure of a backlight module provided by an embodiment of the present disclosure, FIG. 3 is a schematic diagram of a planar structure of a light guide plate provided by an embodiment of the present disclosure.

The backlight module includes a frame body 101, a light reflecting plate 102 disposed in the frame body 101, and a light guide plate 103 disposed on the light reflecting plate 102. The frame body 101 may be a metal frame or a non-metal frame, and the frame body 101 is configured to support and protect each functional element in the backlight module.

Optionally, the backlight module may further refer to a combination of other optical elements capable of emitting light and passing light except for the frame body 101.

Furthermore, the backlight module further includes a first light emitting module 104 and a second light emitting module 105, and the first light emitting module 104 and the second light emitting module 105 each have an independent light emitting function. The first light emitting module 104 provides a first active light source for the backlight module, and under a light emitting action of the first light emitting module 104, the backlight module emits light of a first equal brightness. The second light emitting module 105 provides a second active light source for the backlight module, and under a light emitting action of the second light emitting module 105, or a combined light emitting action of the second light emitting module 105 and the first light emitting module 104, the backlight module emits light of a second equal brightness, so as to realize a change of brightness of the light emitted by the backlight module.

The first light emitting module 104 and the second light emitting module 105 are jointly disposed on a same side edge of the light guide plate 103, and light emitted by the first light emitting module 104 and light emitted by the second light emitting module 105 are incident on the light guide plate 103 along the side edge of the light guide plate 103, and are transmitted in the light guide plate 103.

A plurality of protrusion portions 1032 and a plurality of groove portions 1031 are defined on the side edge of the light guide plate 103 disposed with the first light emitting module 104 and the second light emitting module 105, the plurality of groove portions 1031 include a plurality of first light incident surfaces 1031a, and the plurality of protrusion portions 1032 include a plurality of second light incident surfaces 1032a. The plurality of protruding portions 1032 and the plurality of groove portions 1031 are defined at intervals on the side edge of the light guide plate 103, so that the side edge of the light guide plate 103 forms a concave-convex structure like a great wall-like shape. Wherein each of the protruding portions 1032 is a square protrusion, and each of the groove portions 1031 is a square groove.

Optionally, one or more groove portions 1031 are disposed between two adjacent protruding portions 1032.

Furthermore, the first light emitting module 104 includes a plurality of first light emitting elements L1, each of the first light emitting elements L1 corresponds to one of the groove portions 1031, and each of the first light emitting elements L1 is disposed in a cavity formed by one of the groove portions 1031, and light emitting surfaces of the first light emitting elements L1 face corresponding first light incident surfaces 1031a.

One of the first light emitting elements L1 is disposed in each of the groove portions 1031, and the plurality of first light emitting elements L1 are sequentially disposed along the groove portions 1031 to form the first light emitting module 104.

The second light emitting module 105 includes a plurality of second light emitting elements L2, each of the second light emitting elements L2 is disposed corresponding to one of the protrusion portions 1032, and each of the second light emitting elements L2 is disposed on a convex surface formed by one of the protrusion portions 1032, and light emitting surfaces of the second light emitting elements L2 face corresponding second light incident surfaces 1032a.

One of the second light emitting elements L2 is disposed on a convex surface of each of the protrusion portions 1032, and the plurality of second light emitting elements L2 are sequentially disposed along the protrusion portions 1032 to form the second light emitting module 105.

Furthermore, reflective layers F are disposed on side walls of each of the protrusion portions 1032 close to the adjacent groove portion 1031. The reflective layers F are configured to reflect light emitted by the first light emitting elements L1 and/or the second light emitting elements L2 toward surfaces of the reflective layers F, thereby preventing the light emitted by the first light emitting module 104 from interfering with the light emitted by the second light emitting module 105.

Optionally, edges of the reflective layers F may extend to the first light incident surfaces 1031a and/or the second light incident surfaces 1032a, so that the reflective layers F partially encase the first light incident surfaces 1031a and the second light incident surfaces 1032a. The embodiment can further alleviate a problem of mutual interference between the light emitted by the first light emitting module 104 and the light emitted by the second light emitting module 105.

In the embodiment of the present disclosure, the first light emitting module 104 and the second light emitting module 105 are respectively disposed along the groove portions 1031 and the protrusion portions 1032 of the light guide plate 103, so as to form a front row light source and a rear row light source. Compared with a design of a single-row light source, a design scheme of the present disclosure is beneficial by setting a greater number of light emitting elements on one side edge of the light guide plate, thereby maximum light emitting brightness of the backlight module is improved, a current demand of a single light emitting element can also be reduced at a specific light emitting brightness, which is beneficial to improve a service life of the light emitting elements. And the front row light source and the rear light source can emit light independently, so that the backlight module has an ability to emit light of at least two kinds of brightness, when the first light emitting module and the second light emitting module emit light at the same time, due to the concave-convex structure at least one side edge of the light guide plate, the light emitted by the second light emitting module and the light emitted by the first light emitting module are uniformly integrated, which is beneficial to improving a quality of light emitted by the backlight module.

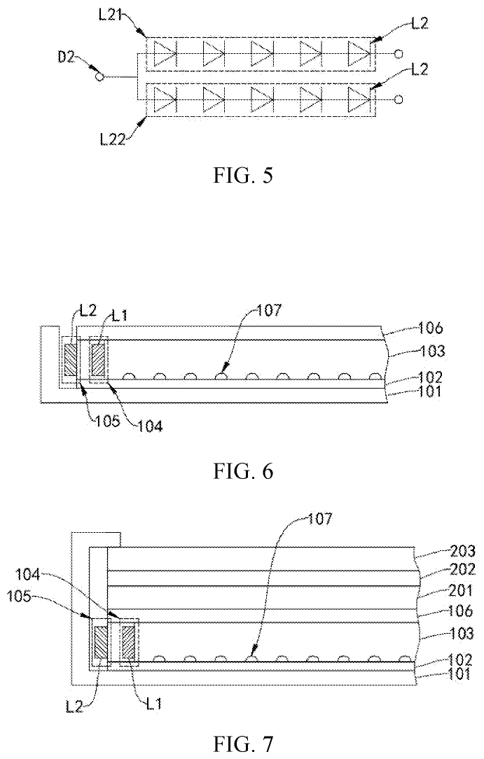

Furthermore, referring to FIG. 1 to FIG. 5, FIG. 4 is a circuit driving schematic diagram of a first light emitting module provided by an embodiment of the present disclosure, FIG. 5 is a circuit driving schematic diagram of a second light emitting module provided by an embodiment of the present disclosure.

The first light emitting module 104 is driven to emit light by a first driving circuit D1, the second light emitting module 105 is driven to emit light by a second driving circuit D2, and the first driving circuit D1 and the second driving circuit D2 are independent of each other. That is, the first driving circuit D1 independently controls turning on or turning off of the first light emitting module 104 and without being affected by the second driving circuit D2, and similarly, the second driving circuit D2 independently controls the turning on or turning off of the second light emitting module 105 and without being affected by the first driving circuit D1, so that the first light emitting module 104 and the second light emitting module 105 may independently emit light.

The first driving circuit D1 and the second driving circuit D2 are both electrically connected to the driving chip, the driving chip is configured to regulate a working timing sequence of the first driving circuit D1 and the second driving circuit D2. For example, when the backlight module emits light with lower brightness in a darker environment, the driving chip controls the first driving circuit D1 to drive the first light emitting module 104, so that the first light emitting module 104 emits light. When the backlight module emits light with higher brightness in a brighter environment, the driving chip controls the first driving circuit D1 to drive the first light emitting module 104, so that the first light emitting module 104 emits light, and at the same time, the driving chip controls the second driving circuit D2 to drive the second light emitting module 105, so that the second light emitting module 105 also emits light.

In some embodiments, all the first light emitting elements L1 in the first light emitting module 104 are connected in series in the first driving circuit D1, and the first driving circuit D1 drives all the first light emitting elements L1 in the first light emitting module 104 to emit light simultaneously or to be turned off simultaneously.

In some embodiments, the first light emitting module 104 includes at least two series groups, which may be a first series group L11, a second series group L12, and a third series group L13 as shown in FIG. 4. The first series group L11 includes a first number of the first light emitting elements L1 connected in series, the second series group L12 includes a second number of the first light emitting elements L1 connected in series, and the third series group L13 includes a third number of the first light emitting elements L1 connected in series. The first number, the second number, and the third number may be equal or different, and the first light emitting elements L1 in series in the first series group L11, the first light emitting elements L1 in series in the second series group L12, and the first light emitting elements L1 in series in the third series group L13 are all different from each other, that is, each of the first light emitting elements L1 is only present in one of the series groups.

The first series group L11, the second series group L12, and the third series group L13 are kept in parallel connection with each other, and the first series group L11, the second series group L12, and the third series group L13 are all driven by the first driving circuit D1 to emit light simultaneously or to be turned off simultaneously.

In the embodiment, the first light emitting module 104 is designed as a plurality of series groups connected in parallel, which is beneficial to reduce an amount of current in each of the series groups and reduce heat production of the first light emitting module 104.

It should be noted that in the embodiment, the first light emitting module 104 is designed to include three series groups connected in parallel, and in other embodiments, the first light emitting module 104 may also be designed to include fewer or more series groups in parallel with each other.

In some embodiments, all the second light emitting elements L2 in the second light emitting module 105 are connected in series in the second driving circuit D2, and the second driving circuit D2 drives all the second light emitting elements L2 in the second light emitting module 105 to emit light simultaneously or to be turned off simultaneously.

In some embodiments, the second light emitting module 105 includes at least two series groups, which may be a fourth series group L21 and a fifth series group L22 as shown in FIG. 5. The fourth series group L21 includes a fourth number of the second light emitting elements L2 connected in series, and the fifth series group L22 includes a fifth number of the second light emitting elements L2 connected in series. The first number and the second number may be equal or different, and the second light emitting elements L2 connected in series in the fourth series group L21 is different from the second light emitting elements L2 connected in series in the fifth series group L22, that is, each of the second light emitting elements L2 is only present in one of the series groups.

The fourth series group L21 and the fifth series group L22 are connected in parallel with each other, and both the fourth series group L21 and the fifth series group L22 are driven by the second driving circuit D2 to emit light or to be turned off simultaneously.

In an embodiment, the second light emitting module 105 is designed as a plurality of series groups connected in parallel, which is beneficial to reduce an amount of current in each of the series groups and reduce heat production of the second light emitting module 105.

It should be noted that in an embodiment, the second light emitting module 105 is designed to include two series groups connected in parallel, and in other embodiments, the second light emitting module 105 may also be designed to include fewer or more series groups in parallel with each other.

Furthermore, please continue to refer to FIG. 2, the first light emitting module 104 emits a first light, and the second light emitting module 105 emits a second light. Wherein, the first light and the second light may be two lights with different colors, or may also be two white lights with different brightness. Wherein, in order to enable the backlight module to emit high-quality backlight under a high-brightness lighting condition, the light emitted by the first light emitting module 104 and the light emitted by the second light emitting module 105 are designed to have a certain gray-scale difference, therefore, brightness and uniformity of a mixed light formed by the first light emitting module 104 and the second light emitting module 105 emitting light simultaneously are improved.

Furthermore, the backlight module includes a light emitting area A, wherein the light emitting area A is an area on the backlight module that allows light to be emitted from the backlight module, and when the backlight module is applied to a display device, the light emitting area A corresponds to a display area of the display device.

Wherein, a distance from the first light emitting module 104 to the light emitting area A is less than a distance from the second light emitting module 105 to the light emitting area A. Since the first light emitting module 104 is relatively close to the light emitting area A, the light emitted by the first light emitting module 104 has a more obvious influence on a light emitting uniformity of the backlight module, when the light emitting uniformity of the backlight module is adjusted, only the light emitted by the first light emitting module 104 needs to be adjusted. A method for adjusting the light emitting uniformity of the backlight module is to adjust a number and a distribution of scattering dots in the backlight module.

Further, the backlight module includes at least a first light emitting mode and a second light emitting mode. In the first light emitting mode, the first light emitting module 104 emits light, and the second light emitting module 105 does not emit light, at this time, brightness of the light emitted by the backlight module is relatively low, which is suitable for display under darker ambient light. In the second light emitting mode, both the first light emitting module 104 and the second light emitting module 105 emit light, at this time, brightness of the light emitted by the backlight module is relatively high, which is suitable for display under brighter ambient light.

In addition, in order to realize that the backlight module emits light of more kinds of brightness, the driving chip may adjust a current of the first light emitting module 104 and a current of the second light emitting module 105, so that the first light emitting module 104 and the second light emitting module 105 switch between different light emitting brightness.

In an embodiment of the present disclosure, please refer to FIG. 6, FIG. 6 is a schematic structural diagram of a second film layer of a backlight module provided by an embodiment of the present disclosure. The backlight module shown in FIG. 6 has a same or similar structure as the backlight module shown in FIG. 1, structural features of the backlight module shown in FIG. 6 are described below, and which are not described in detail, please refer to embodiments described above.

The backlight module includes a frame body 101, a light reflecting plate 102 disposed in the frame body 101, a light guide plate 103 disposed on the light reflecting plate 102, and an optical film group 106 disposed on the light guide plate 103.

The optical film group 106 is configured to enhance light emitting brightness and light emitting uniformity of the backlight module. The optical film group 106 may include a diffusion plate for realizing light diffusion, a prism sheet for realizing multi-angle refraction and reflection of light, and a brightness enhancement plate for realizing light brightness enhancement.

The light reflecting plate 102 is configured to reflect light irradiated to surfaces thereof back to the light guide plate 103, so as to enhance light intensity in the light guide plate 103. Light scattering dots 107 are disposed at an interface between the light reflecting plate 102 and the light guide plate 103, and the light scattering dots 107 are configured to scatter light irradiated to surfaces thereof, and reflect the light in multiple directions, so as to increase uniformity of light intensity distribution in the light guide plate 103

Please refer to FIG. 6 and FIG. 3, a plurality of protrusion portions 1032 and a plurality of groove portions 1031 are disposed on at least one side edge of the light guide plate 103. The protrusion portions 1032 and the groove portions 1031 are alternately distributed on at least one side edge of the light guide plate 103, so that the at least one side edge of the light guide plate 103 forms a concave-convex structure like a great wall-like shape.

The backlight module also includes the first light emitting module 104 and the second light emitting module 105. The first light emitting module 104 and the second light emitting module 105 each have an independent light emitting function. The first emitting light module 104 provides a first active light source for the backlight module, and the second light emitting module 105 provides a second active light source for the backlight module. Under a light emitting action of the first light emitting module 104 and/or the second light emitting module 105, the backlight module emits light of different brightness, so as to realize a change of brightness of the light emitted by the backlight module.

The first light emitting module 104 includes a plurality of first light emitting elements L1, each of the first light emitting elements L1 corresponds to one of the groove portions 1031, and each of the first light emitting elements L1 is disposed in a cavity formed by one of the groove portions 1031. The second light emitting module 105 includes a plurality of second light emitting elements L2, each of the second light emitting elements L2 is disposed corresponding to one of the protrusion portions 1032, and each of the second light emitting elements L2 is disposed on a convex surface formed by one of the protrusion portions 1032.

In an embodiment of the present disclosure, the first light emitting module 104 and the second light emitting module 105 are respectively disposed along the groove portions 1031 and the protrusion portions 1032 of the light guide plate 103, so as to form a front row light source and a rear row light source. Compared with a design of a single-row light source, a design scheme of the present disclosure is beneficial by setting a greater number of light emitting elements on one side edge of the light guide plate, thereby maximum light emitting brightness of the backlight module is improved, a current demand of a single light emitting element can also be reduced at a specific light emitting brightness, which is beneficial to improve a service life of the light emitting elements. And the front row light source and the rear light source can emit light independently, so that the backlight module has an ability to emit light of at least two kinds of brightness, when the first light emitting module and the second light emitting module emit light at the same time, due to the concave-convex structure at least one side edge of the light guide plate, the light emitted by the second light emitting module and the light emitted by the first light emitting module are uniformly integrated, which is beneficial to improving a quality of light emitted by the backlight module.

The first light emitting module 104 emits a first light, and the second light emitting module 105 emits a second light. Wherein, the first light and the second light may be two light with different colors, or may also be two white light with different brightness.

A distance from the first light emitting module 104 to the light emitting area is less than a distance from the second light emitting module 105 to the light emitting area. When the light emitting uniformity of the backlight module is adjusted, only the light emitted by the first light emitting module 104 needs to be adjusted. A method for adjusting light emitting uniformity of the backlight module is to adjust a number and a distribution of the light scattering dots 107 in the backlight module.

In summary, the backlight module provided by an embodiment of the present disclosure includes a light guide plate, a first light emitting module, and a second light emitting module, a plurality of protrusion portions and a plurality of groove portions are defined on at least one side edge of the light guide plate, the first light emitting module includes a plurality of first light emitting elements, each of the first light emitting elements is correspondingly disposed in the cavity of one of the groove portions; the second light emitting module includes a plurality of second light emitting elements, each of the second light emitting elements is correspondingly disposed on the convex surface of one of the protrusion portions. In an embodiment of the present disclosure, two groups of independent light emitting modules are provided, and two groups of light emitting modules are respectively disposed corresponding to the groove portions and the protrusion portions of the light guide plate, which is beneficial by setting a greater number of light emitting elements on one side edge of the light guide plate, thereby maximum light emitting brightness of the backlight module is improved, a current demand of a single light emitting element can be reduced at a specific light emitting brightness, which is beneficial to improve a service life of the light emitting elements. And the front row light source and the rear light source can also emit light independently, so that the backlight module has an ability to emit light of at least two kinds of brightness, when the first light emitting module and the second light emitting module emit light at the same time, due to the concave-convex structure at least one side edge of the light guide plate, the light emitted by the second light emitting module and the light emitted by the first light emitting module are uniformly integrated, which is beneficial to improving quality of light emitted by the backlight module.

An embodiment of the present disclosure further provides a display device, please refer to FIG. 7, FIG. 7 is a schematic structural diagram of a display device provided by an embodiment of the present disclosure. The display device includes the backlight module provided by the embodiments as described above in the present disclosure, and a display panel disposed on a light emitting surface of the backlight module.

Specifically, the display device includes: a frame body 101, a light reflecting plate 102 disposed in the frame body 101, a light guide plate 103 disposed on the light reflecting plate 102, an optical film group 106 disposed on the light guide plate 103, an array substrate 201 disposed on the optical film group 106, a color film substrate 203 disposed on the array substrate 201, and a liquid crystal layer 202 disposed between the array substrate 201 and the color film substrate 203.

Light scattering dots 107 are disposed at an interface between the light reflecting plate 102 and the light guide plate 103, a first light emitting module 104 and a second light emitting module 105 are disposed on at least one side edge of the light guide plate 103. The first light emitting module 104 includes a plurality of first light emitting elements L1, and the second light emitting module 105 includes a plurality of second light emitting elements L2. The first light emitting elements L1 are disposed corresponding to groove portions of the light guide plate 103, and the second light emitting elements L2 are disposed corresponding to protruding portions of the light guide plate 103.

The display device provided by an embodiment of the present disclosure has two groups of light emitting modules, which can achieve a higher brightness display; and a current demand of a single light emitting element can be reduced at a specific light emitting brightness, which is beneficial to improve the service life of the light emitting elements; and the front row light source and the rear light source can emit light independently, so that the display device has a variety of display brightness, and due to a concave-convex structure at least one side edge of the light guide plate, the light emitted by the second light emitting module and the light emitted by the first light emitting module are uniformly integrated, thereby improving display brightness uniformity of the display device.

It should be noted that although the present disclosure has been disclosed by specific embodiments, the above embodiments are not intended to limit the present disclosure, and for those of ordinary skill in the art, various changes and modifications may be made without departing from the spirit and scope of the present disclosure, and therefore, the protection scope of the present disclosure is subject to the scope defined by the claims.

What is claimed is:

1. A backlight module, is characterized by comprising:
a light guide plate, wherein a plurality of protrusion portions and a plurality of groove portions are defined on at least one side edge of the light guide plate, and the plurality of groove portions comprise a plurality of first light incident surfaces, and the plurality of protrusion portions comprise a plurality of second light incident surfaces;
a first light emitting module, wherein the first light emitting module comprises a plurality of first light emitting elements, the first light emitting elements are disposed corresponding to the groove portions, and light emitting surfaces of the first light emitting elements face corresponding first light incident surfaces; and
a second light emitting module, wherein the second light emitting module comprises a plurality of second light emitting elements, the second light emitting elements are disposed corresponding to the protruding portions, and light emitting surfaces of the second light emitting elements face corresponding second light incident surfaces.

2. The backlight module of claim 1, is characterized in that, wherein the first light emitting module is driven to emit light by a first driving circuit, the second light emitting module is driven to emit light by a second driving circuit; and
the first driving circuit and the second driving circuit are independent of each other.

3. The backlight module of claim 2, is characterized in that, wherein the backlight module comprises a first light emitting mode and a second light emitting mode;
in the first light emitting mode, the first light emitting module emits light, and the second light emitting module does not emit light;
in the second light emitting mode, both the first light emitting module and the second light emitting module emit light.

4. The backlight module of claim 3, is characterized in that, wherein the first light emitting module emits a first light, the second light emitting module emits a second light, and the first light and the second light are different from each other.

5. The backlight module of claim 4, is characterized in that, wherein a brightness of the first light is different from a brightness of the second light.

6. The backlight module of claim 1, is characterized in that, wherein reflective layers are disposed on side walls of each of the protruding portions close to adjacent groove portions.

7. The backlight module of claim 6, is characterized in that, wherein the reflective layers cover partial edge areas of the first light incident surfaces.

8. The backlight module of claim 6, is characterized in that, wherein the reflective layers cover partial edge areas of the second light incident surfaces.

9. The backlight module of claim 1, is characterized in that, wherein the backlight module comprises a light emitting region, and a distance from the first light emitting module to the light emitting region is less than a distance from the second light emitting module to the light emitting region.

10. The backlight module of claim 1, is characterized in that, wherein the plurality of protruding portions and the plurality of groove portions are defined spaced apart from each other.

11. The backlight module of claim 1, is characterized in that, wherein one or more groove portions are defined between two adjacent protruding portions.

12. The backlight module of claim 1, is characterized in that, wherein the first light emitting module comprises a first series group and a second series group, the first series group comprises a first number of the first light emitting elements connected in series, the second series group comprises a second number of the first light emitting elements connected in series, and the first series group and the second series group are connected in parallel.

13. The backlight module of claim 2, is characterized in that, wherein all the first light emitting elements in the first light emitting module are connected in series in the first driving circuit.

14. The backlight module of claim 1, is characterized in that, wherein the second light emitting module comprises a third series group and a fourth series group, the third series group comprises a third number of the second light emitting elements connected in series, the fourth series group comprises a fourth number of the second light emitting elements connected in series, and the third series group and the fourth series group are connected in parallel.

15. The backlight module of claim 2, is characterized in that, wherein all the second light emitting elements in the second light emitting module are connected in series in the second driving circuit.

16. The backlight module of claim 1, is characterized in that, wherein the backlight module further comprises a frame body and a light reflecting plate, the light reflecting plate and the light guide plate are both disposed in the frame body, and the light guide plate is disposed on the light reflecting plate.

17. The backlight module of claim 16, is characterized in that, wherein the backlight module further comprises an optical film group disposed on the light guide plate, and the optical film group comprises a diffusion plate, a prism sheet, and a brightness enhancement plate.

18. The backlight module of claim 16, is characterized in that, wherein light scattering dots are disposed at an interface between the light reflecting plate and the light guide plate, and the light scattering dots are configured to scatter light irradiated to surfaces thereof.

19. A display device, is characterized by comprising:
the backlight module of claim 1; and
a display panel disposed on a light emitting surface of the backlight module.

20. A display device, is characterized by comprising a backlight module, and a display panel disposed on a light emitting surface of the backlight module; wherein the backlight module comprises:
a light guide plate, wherein a plurality of protrusion portions and a plurality of groove portions are defined on at least one side edge of the light guide plate, the plurality of groove portions comprise a plurality of first light incident surfaces, the plurality of protrusion portions comprise a plurality of second light incident surfaces, and reflective layers are disposed on side walls of each of the protruding portions close to adjacent groove portions;
a first light emitting module, wherein the first light emitting module comprises a plurality of first light emitting elements, the first light emitting elements are disposed corresponding to the groove portions, and light emitting surfaces of the first light emitting elements face corresponding first light incident surfaces; and
a second light emitting module, wherein the second light emitting module comprises a plurality of second light emitting elements, the second light emitting elements are disposed corresponding to the protruding portions, and light emitting surfaces of the second light emitting elements face corresponding second light incident surfaces;
wherein the first light emitting module and the second light emitting module emits light independently of each other.
